(19) United States
(12) Patent Application Publication
(10) Pub. No.: US 2020/0055179 A1
(43) Pub. Date: Feb. 20, 2020

(54) EQUIPMENT FOR THE MANAGEMENT OF SETS OF INTERCHANGEABLE BUTTONS, AND INTERCHANGEABLE BUTTONS HANDLING AND SUBSTITUTION KIT

(71) Applicant: BOTT-ON S.R.L., Bologna (IT)

(72) Inventor: Marco Sassoli De' Bianchi, Bologna (IT)

(21) Appl. No.: 16/342,449

(22) PCT Filed: Oct. 17, 2017
(86) PCT No.: PCT/IB2017/056426

§ 371 Date: Apr. 16, 2019

(30) Foreign Application Priority Data
Oct. 20, 2016 (IT) 102016000105884

(51) Int. Cl. B25H 3/02; A44B 1/08; A45F 3/48; D05B 91/12

(52) U.S. Cl. CPC B25H 3/022; D05B 91/12; A45F 3/48; A44B 1/08

(57) ABSTRACT

A set (200) of interchangeable buttons (2) are adapted to be applied or substituted in a garment (V) with equipment (1) that includes a container (10) with multiple compartments (11) defining a group of housings having the shape of a well (12) for as many groups (20) of buttons (2) arranged in a stack; a tray (13) adapted to contain coupling means (3); at least one seat (14) adapted to contain a tool (4, 5); closing means (18), associated to the container (10) and moving between an open position and a closed one, in the first of which the compartments (11) are made accessible for the withdrawal and/or placement of the interchangeable buttons (2), coupling means (3) and tool (4, 5), while in the second position the same compartments (11) are protected and mutually isolated, so as to prevent the transfer of the contents of one into another and vice versa.

### TECHNICAL FIELD

The invention lies within the technical field of components for clothes and, in particular, it relates to equipment for handling the application and/or replacement of interchangeable buttons.

### BACKGROUND ART

The Applicant filed the Italian Patent Applications Nos. 102015000032600 and 102016000052544, on 9 Jul. 2015 and 23 May 2016, respectively, which claim various characteristics of a button for garments, provided with a removable support element.

In both above mentioned inventions, the support element, or coupling element, consists substantially of a screw, whose threaded stem passes in a hole provided on purpose in the garment and is engaged by a threaded hole of the button, placed on the opposite side of the garment.

Therefore, the button can be replaced with another one having a different shape and/or colour or temporarily removed.

The above described inventions offer as many technical solutions for brilliantly overcoming inherent limitations of the conventional technique, according to which the buttons are fastened to the garment by stitching.

In fact, the interchangeable button allows to customize and/or adapt the garment each time it is desired, obtaining a better colour, material or another match with other garments or accessories that will be worn together.

Moreover, if necessary, it is possible to easily remove the buttons during the garment wash, for example, if they are made of delicate materials and can be damaged, or, on the contrary, it could happen that the buttons damage the garment, for example, by undesired colour release.

### TECHNICAL PROBLEM

However, the potential of such buttons is carelessly handled with the conventional mode adopted in the domestic treatment of buttons; the spare buttons, of all kinds of shapes, are usually kept haphazardly in a box, thus it is not known how many different types of buttons and how many buttons of each type there are.

This means that every time it is necessary to intervene, a long arduous and uncertain search work is needed to find what is wanted.

It is understood that a more regular and functional approach is needed to exploit the potential of the interchangeable buttons.

### OBJECTS OF THE INVENTION

Therefore, the object of the present invention is to propose an equipment for handling sets of interchangeable buttons, conceived so as to make it simple and rapid to apply the above mentioned buttons to a garment or remove them to replace them, in particular by means of a container having compartments adapted to contain orderly all the identical buttons.

Another object of the invention is to propose a container comprising closing means which are capable of isolating each compartment from the others, when the container is closed, thus preventing the transfer of the contents of one into another and vice versa.

Yet another object of the invention is to provide other compartments in the container, shaped in such a way as to contain the coupling means for buttons and to define seats for the tools used to apply and/or remove the buttons, so as to have them always at hand.

A further object of the invention is to provide the container with dedicated tools, capable of optimizing its usability during taking the buttons from various compartments.

A still further object of the invention is to prepare a set of interchangeable buttons to be sold together with the container and its tools, in such a way that the user who buys the complete container has everything that is needed.

A yet further object of the invention is to contain the production costs of the equipment within reasonable limits, so as to propose it at a price affordable to everyone.

### SUMMARY OF THE INVENTION

These and other objects are fully obtained by means of an equipment for handling sets of interchangeable buttons destined to be applied or replaced in a garment, with said set of interchangeable buttons comprising: a plurality of groups of said buttons, each of which is formed by homogeneous buttons; a plurality of coupling means, designed to mate with said interchangeable buttons in order to removably fasten the latter to said garment; at least one tool for handling said buttons and/or coupling means during operations in which the cited buttons are applied to the above garment or removed therefrom to be replaced with others; said equipment comprising:
a container with multiple compartments, of which: a group of compartments composed of as many housings having the shape of a well and having such a section as to receive corresponding groups of interchangeable buttons in a prearranged manner, set in almost vertical stacks; at least another of these compartments constituted by a tray adapted to contain said coupling elements; at least another of these compartments provided to define a seat adapted to contain said tool;
closing means, associated to the container with multiple compartments, movable between at least two positions, namely an open position and a closed position, in the first of which the compartments are made accessible for the withdrawal and/or placement of the above mentioned interchangeable buttons, coupling means and tool, while in the second position the same compartments are protected and mutually isolated, so as to prevent the transfer of the contents of one into another and vice versa.

### BRIEF DESCRIPTION OF THE DRAWINGS

The distinguishing features of the invention will become evident from the following description of a preferred embodiment of the equipment for handling a set of interchangeable buttons and a proposed kit for the application or replacement of interchangeable buttons in a garment, according to the contents of the claims and with the help of the enclosed drawings, in which:

FIG. 1 is a perspective view of the two elements that form an interchangeable button;

FIG. 2 is a lateral view of a first tool for taking one element of the buttons of FIG. 1;

FIG. 3 is a front view of the tool of FIG. 2;

FIG. 4 is a lateral view of a second tool for handling the coupling means of the mentioned buttons of FIG. 1;

FIG. 5 illustrates a portion of the tool of FIG. 4 during a working step;

FIG. 6 is a plan view of a container with multiple compartments destined to house the buttons and tools;

FIG. 7 is similar to the view of FIG. 6, with the container provided with the relative sliding covers;

FIG. 8 is a bottom view of the container aimed at pointing out holes made in the bottom;

FIG. 9 is a section view, in enlarged scale, taken along the plane IX-IX of FIG. 6.

### DESCRIPTION OF PREFERRED EMBODIMENTS OF THE INVENTION

In the above listed figures the reference 1 indicates the equipment for handling sets of interchangeable buttons 2, as a whole, proposed by the present invention.

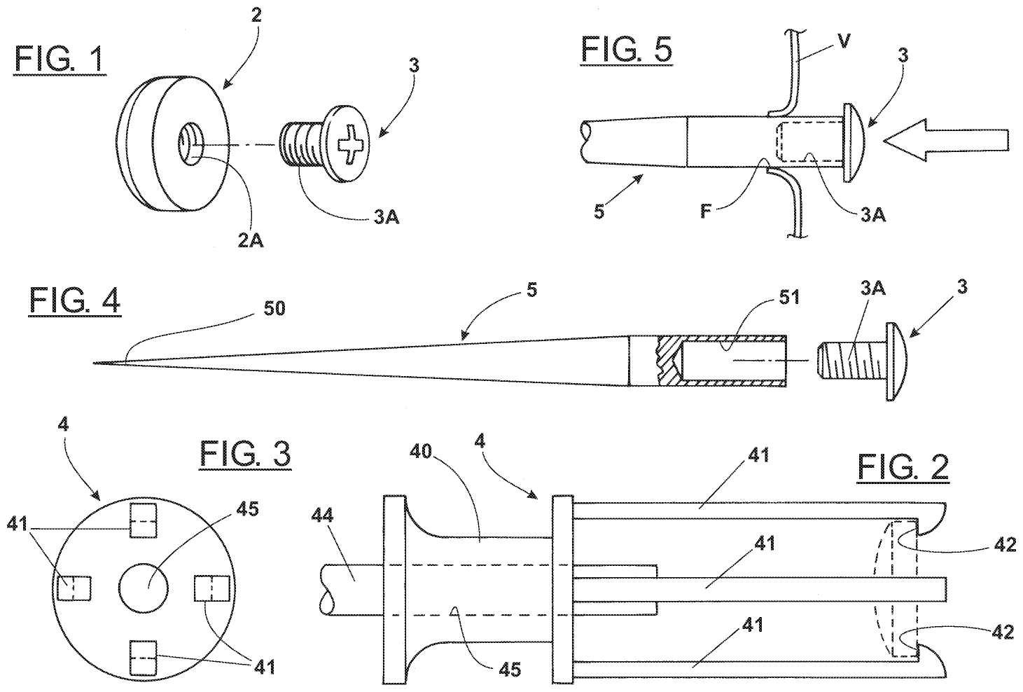

The interchangeable buttons 2, mentioned in the introductory note, are preferably of the kind illustrated in FIG. 1 and are provided with a removable support element 3.

The support element 3, or coupling element according to the technical teachings contained in the Patent Application for Industrial Invention mentioned in the introductory note, is substantially a screw, whose threaded stem 3A is adapted to pass in a hole F, made on purpose in a garment V, to subsequently engage a threaded hole 2A of the button 2.

In view of this constructive characteristic, the interchangeable buttons 2 can be applied to the garment V without stitching and easily removable so as to be rapidly replaced, if necessary, with other buttons of a different shape or colour or temporarily removed.

The reference number 200 indicates a set of interchangeable buttons 2 comprising: a plurality of groups 20 of said buttons 2, each of which groups 20 being formed by homogeneous buttons 2; a plurality of coupling means 3, in this case screws, intended to couple with the interchangeable buttons 2.

The set 200 includes at least a tool for handling the buttons 2 and/or coupling means 3 during the operations, in which the buttons 2 are applied to the garment V or removed to be replaced with others.

Advantageously, the illustrative set 200 includes a first tool 4 for handling the buttons 2 and a second tool 5 for handling the coupling means 3 and having a supplementary function, as will be better explained in the following.

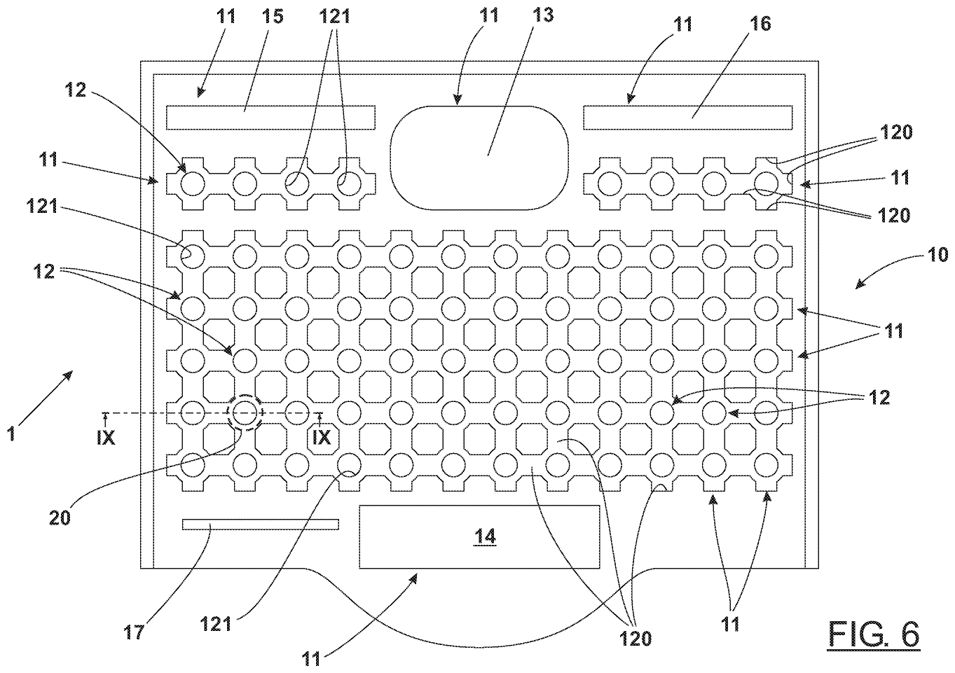

According to the invention, the equipment 1 includes a container 10 with multiple compartments 11, among which:
a group of housings 12, having the shape of a well and having such a section as to receive corresponding groups 20 of interchangeable buttons 2 in a prearranged manner, set in almost vertical stacks;
at least a tray 13 intended to contain the coupling means 3, arranged haphazardly;
a suitable number of seats, designed to contain said tools 4, 5; the example illustrated in FIG. 6 shows three seats 14, 15, 16, one of which can be available for other things.

Advantageously, one of the multiple compartments 11 of the container 10 is a slot housing 17 (FIG. 6) so designed as to house an instruction manual (not shown), describing operations for applying the aforementioned buttons 2 to the garment V or removing them to be replaced with others.

The container 10, in a preferred, but not exclusive embodiment, has a form of a tray and is obtained by two pieces of molded plastic material, joined like a shell.

The cited well-like housings 12 are arranged in parallel rows in the container 10, with each of the housings having four cross-like grooves 120, arranged outside of the lateral surface of the well-like housing 12 and extending to the depth thereof, so as to define passage areas through which said first tool 4 is adapted to pass.

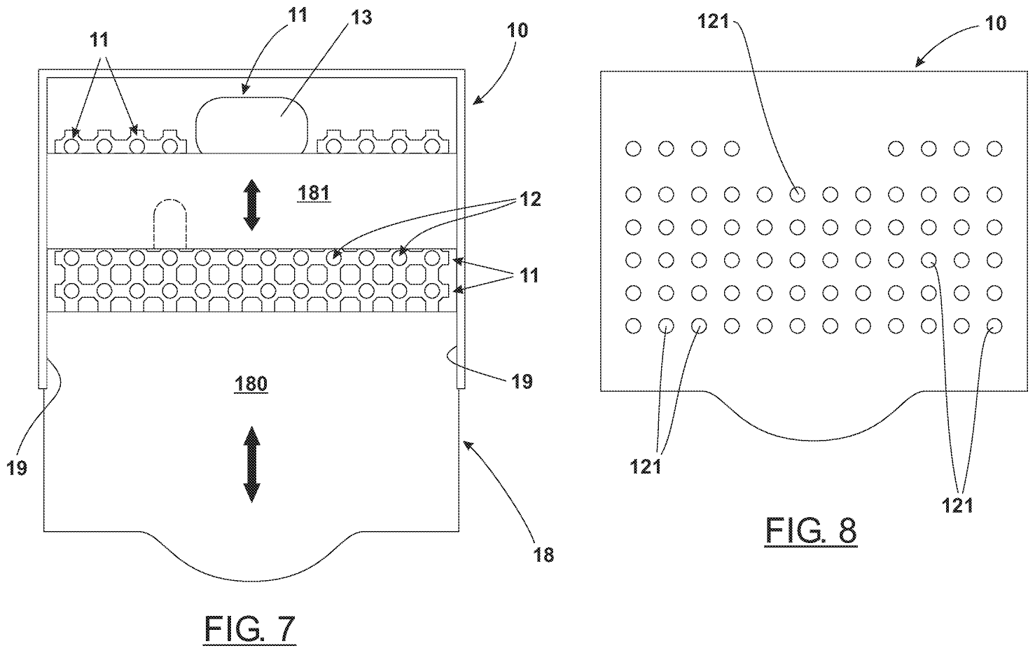

With reference to FIGS. 6, 7, there is therein pointed out how the grooves 120 of a well-like housing 12 get in communication with those of the adjacent housings 12, both in horizontal and vertical direction.

This allows to optimize the use of the space, facilitate handling of the first tool 4 and simplify the mold shape.

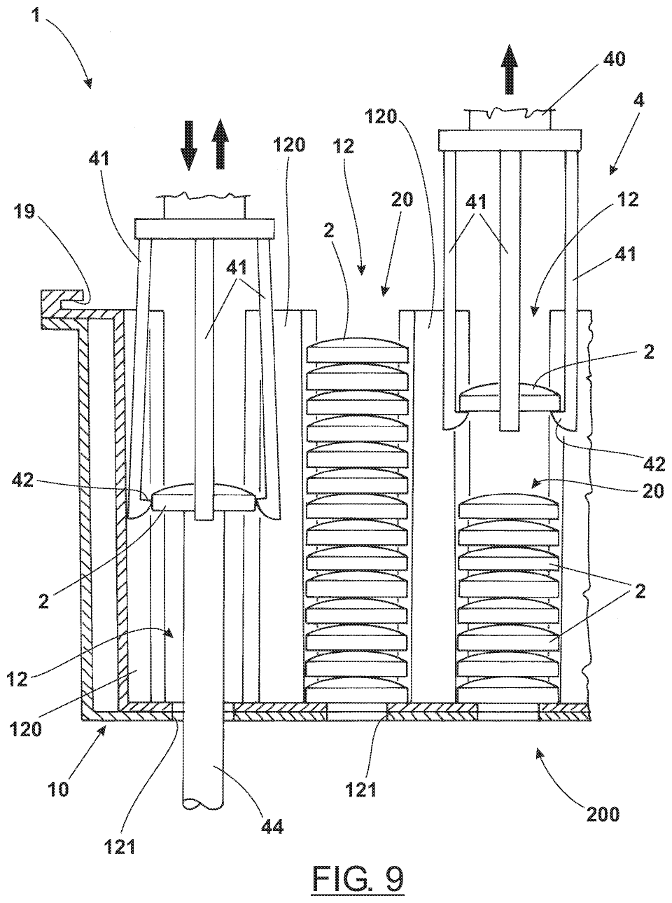

Each of the cited well-like housings 12 has a hole 121 made in its bottom, in communication with the outside, whose function will become evident later on (see in particular FIGS. 8 and 9).

The container 10 is provided with closing means 18, moving between at least two positions, an open position and a closed one, in the first of which the compartments 11 are made accessible for the withdrawal and/or placement of the interchangeable buttons 2, coupling means 3 and tools 4, 5,

while in the second position the same compartments 11 are protected and mutually isolated, so as to prevent the transfer of the contents of one into another and vice versa.

The cited closing means 18, of the not limiting example of FIG. 7, are of the shutter type and have two bulkheads, a main bulkhead 180 and a secondary bulkhead 181, sliding in a plane parallel to the surface of the cited container 10, along the guides 19 made therein.

The main bulkhead 180 covers the area of the well-like housings 12 and, when in its closed position, it blocks the secondary bulkhead 181, which covers the tray 13, some other well-like housings 12 and the seats 15, 16.

The main bulkhead 180 can be withdrawn wholly or partially (FIG. 7) and is stabilised automatically due to friction with the guides 19.

However, blocking means (not shown) can be provided to stabilize the closed position of the main bulkhead 180.

The above mentioned first tool 4, having the shape of pliers, is destined to withdraw the cited buttons 2 from a respective well-like housing 12 and includes a handle 40, from which four prongs 41 extend, arranged along a circumference and angularly spaced by 90° (FIGS. 4 and 5). The prongs 41 are resiliently flexible and each of them is provided with a gripping tooth 42 situated at the end and turned inside.

The prongs 41 are intended to enter the side grooves 120 of a well-like housing 12 until the first button 2 of the stack is reached so as to snap-engage it with the cited teeth 42 and allow its withdrawal (right side of FIG. 9).

The first tool 4 is functionally associated with a stand-alone auxiliary rod 44, having for example a cylindrical shape.

The auxiliary rod 44 is intended to be introduced, from the bottom, in the above mentioned holes 121 to raise the last buttons 2 of a stack during their withdrawal from the respective well-like housing 12, thus facilitating its hooking by the teeth 42 of the prongs 41 (left side of FIG. 9).

Advantageously, the auxiliary rod 44 allows to support, from the bottom, the stacks of buttons 2 during their introduction in the corresponding well-like housings 12, preventing the buttons 2 from overturning.

The auxiliary rod 44, when not in use, can be introduced in an axial hole 45 made in the handle 40 (FIG. 3) or put away in said free seat 16.

The above mentioned second tool 5 has a substantially needle-like shape, with a pointed tip 50 at one end, and a seat 51 at the opposite end, defined by an blind axial hole (FIG. 4).

The pointed tip 50, when needed, allows to make the mentioned holes F in the garment V to receive, as already said, the corresponding coupling means 3.

During the perforating operation of the garment V (FIG. 5), the seat 51 advantageously receives the stem 3A of a screw 3 designed to couple with a respective interchangeable button 2.

The head of the screw 3, protruding from the site 51, acts as a push-button to press the pointed tip 50; when the second tool 5 has passed through the whole garment V, the stem 3A of the screw 3 remains engaged in the hole F, while the second tool can be withdrawn.

Depending on the type of material of which the garment V is made, it may be necessary to use the second tool 5 for the reverse operation, that is to remove the screws 3; in such a case, the second tool 5 is provided with a protection (not shown) for the pointed tip 50, for example, made of a ball of a rubber-like material, in which the tip 50 can be stuck.

The core of the invention is the described container 10 with multiple compartments 11. However, it is considered to merchandize this article optionally provided with the above mentioned set 200 of interchangeable buttons 2, consequently comprising said first and second tools 4, 5; in this way, the user can have everything that is needed to apply, replace or remove the buttons.

The distinguishing features of the invention become extremely evident from the above description. First of all, due to the container with compartments, the invention allows to keep everything in perfect order, which is an important condition for best carrying out the application and replacement of the buttons, rapidly and all the times it is desired.

The shutter-like closing means are essential for obtaining a really functional container, as they isolate one compartment from others, preventing their contents from mixing during the transport and, at the same time, optimize the usability of withdrawal of the buttons from various compartments.

The option that includes the complete set, the container and the buttons, as well as the tools and instructions, is undoubtedly the best commercial strategy to promote also an original and innovative system consisting of the described interchangeable buttons.

The simplicity of the chosen technical solutions allows to keep the equipment production costs within reasonable limits, so as to propose it to anyone at affordable prices.

It is understood that what has been described above, is illustrative and not limiting, therefore, possible variants of details, which could become necessary because of technical and/or functional reasons, are considered from now on within the same protective scope defined by the claims below.

1. Equipment for management of sets of interchangeable buttons which are intended to be applied or replaced in a garment (V), said set (200) of interchangeable buttons (2) comprising: a plurality of groups (20) of said buttons (2), each of which group (20) is formed by homogeneous buttons (2); a plurality of coupling means (3), designed to mate with said interchangeable buttons (2) in order to removably fasten the latter to said garment (V); at least a tool (4, 5) for handling said buttons (2) and/or coupling means (3) during operations in which the cited buttons (2) are applied to the above garment (V) or removed therefrom to be replaced with others; said equipment (1) being characterized by including:
a container (10) with multiple compartments (11), of which: a group of compartments composed of as many housings (12) having the shape of a well and having such a section as to receive corresponding groups (20) of interchangeable buttons (2) in a prearranged manner, set in almost vertical stacks; at least another of these compartments (11) constituted by a tray (13) adapted to contain said coupling elements (3); at least another of these compartments (11) provided to define a seat (14) adapted to contain said tool (4, 5);
closing means (18), associated to said container (10) with multiple compartments (11), movable between at least two positions, namely open and closed ones, in the first of which said compartments (11) are made accessible for the withdrawal and/or placement of said interchangeable buttons (2), coupling means (3) and tool (4, 5), while in the second position the compartments (11) are protected and mutually isolated, so as to prevent the transfer of the contents of one into another and vice versa.

2. Equipment according to claim 1, characterized in that said welllike housings (12) are arranged in parallel rows, with each of the housings featuring at least two opposed grooves (120) arranged outside of the lateral surface of the well-like housing (12) and extended to the depth thereof, said grooves being designed to define passage areas through which a first tool (4) for handling the afore cited buttons (2) is adapted to pass.

3. Equipment according to claim 2, characterized in that said first tool (4) is intended for taking the above mentioned buttons (2) from a relative well-like housing (12), and comprises a handle (40), from which at least two prongs (41) extend, which are diametrically opposed and resiliently flexible, each of the prongs being provided, at its end, with a gripping tooth (42), turned inward, said prongs (41) being intended to engage in said side grooves (120) of a well-like housing (12) until the first button (2) of the stack present therein is reached, in order to snap-engage it by means of the aforesaid teeth (42) and to allow extraction thereof.

4. Equipment according to claim 3, characterized in that a hole (121) is made in the bottom of each of said well-like housings (12), the hole being in communication with the outside, and in that said first tool (4) includes an auxiliary rod (44), intended to be introduced, from the bottom, in said holes (121) to support said buttons (2) during their introduction or withdrawal into/from said well-like housings (12).

5. Equipment according to claim 1, characterized in that it includes a second tool (5) for handling said coupling means (3), during which handling operations said coupling means are applied to the above mentioned garment (V), or are supported during the removal of said buttons (2), said second tool (5) having a pointed tip (50) at one end, the tip being designed to make a hole (F) in said garment (V), said hole (F) being provided for receiving and retaining one of said coupling means (3) for the interchangeable buttons (2), said second tool (5) comprising a seat (51) at the opposite end, the seat being adapted to receive a stem (3A) of said coupling means (3), the stem being designed to mate with a respective interchangeable button (2).

6. Equipment according to claim 1, characterized in that one of said multiple compartments (11) in the container (10) is constituted by a slot housing (17) and is adapted to receive an instruction manual, describing operations for applying the aforementioned buttons (2) to the above garment (V) or removing them to be replaced with others.

7. Set for the application or replacement of sets of interchangeable buttons in a garment (V), characterized by including:
a plurality of groups (20) of interchangeable buttons (2), each of which group (20) is formed by homogeneous buttons (2);
a plurality of coupling means (3), designed to mate with said interchangeable buttons (2) in order to removably fasten the latter to said garment (V);
at least a tool (4, 5) for handling said buttons (2) and/or coupling means (3) during the operations in which said buttons (2) are applied to said garment (V) or removed therefrom to be replaced with others;
a container (10) with multiple compartments (11), of which: a group of them is provided to define as many housings having the shape of a well (12), which are shaped to receive corresponding groups (20) of said interchangeable buttons (2) in a prearranged manner; at least another of such compartments (11) provided to define a tray (13) adapted to contain said coupling means (3); at least another of these compartments (11) provided to define a seat (14, 15) adapted to contain said tool (4, 5);
closing means (18), associated to said container (10) with multiple compartments (11), movable between at least two positions, namely open and closed ones, in the first of which said compartments (11) are made accessible for the withdrawal and/or placement of the above mentioned interchangeable buttons (2), coupling means (3) and tool (4, 5), while in the second position the same compartments (11) are protected and mutually isolated, so as to prevent the transfer of the contents of one into another and vice versa.
